(19) United States
(12) Patent Application Publication
(10) Pub. No.: US 2025/0022043 A1
(43) Pub. Date: Jan. 16, 2025

(54) METHODS AND SYSTEMS OF FACILITATING INTERACTIVE SEARCH AND DISCOVERY OF REAL ESTATE PROPERTIES

(71) Applicant: SY Interiors Pvt. Ltd., New Delhi (IN)

(72) Inventors: Sunder Jagannathan, Coimbatore (IN); Vivek Agarwal, Faridabad (IN); Hitesh Singla, Gurgaon (IN); Piyush Bothra, Gurgaon (IN)

(73) Assignee: SY Interiors Pvt. Ltd., New Delhi (IN)

(21) Appl. No.: 18/221,415

(22) Filed: Jul. 13, 2023

(51) Int. Cl. G06Q 30/0601; G06Q 50/16; G06T 13/40; G06T 19/00

(52) U.S. Cl. CPC G06Q 30/0643; G06Q 30/0627; G06Q 50/16; G06T 13/40; G06T 19/003

(57) ABSTRACT

The present disclosure provides a method of facilitating interactive search and discovery of real estate properties. Also, the method may include receiving one or more requests from one or more user devices associated with one or more users, retrieving one or more digital twins of one or more geographical areas based on the one or more requests, obtaining one or more real estate data associated with the one or more real estate properties based on the one or more requests, generating one or more interactive representations of the one or more geographical areas based on the one or more digital twins and the one or more real estate data, transmitting the one or more interactive representations to the one or more user devices, receiving inputs from the one or more user devices, and generating exploring parameters.

### FIELD OF DISCLOSURE

The present disclosure generally relates to the field of data processing. More specifically, the present disclosure relates to methods and systems of facilitating interactive search and discovery of real estate properties.

### BACKGROUND

The field relating to data processing is technologically important to several industries, business organizations, and/or individuals.

Existing techniques of facilitating interactive search and discovery of real estate properties are deficient in several ways. For instance, current technologies do not provide an interactive experience to a user for searching, discovering, and viewing a real estate property in a locality. Further, current technologies do not allow a user to interactively view the real estate property and corresponding information in a virtual world.

Therefore, there is a need for methods and systems of facilitating interactive search and discovery of real estate properties that may overcome one or more of the above-mentioned problems and/or limitations.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of facilitating interactive search and discovery of real estate properties. Also, the method may include receiving, using a communication device, one or more requests from one or more user devices associated with one or more users. Further, the method may include retrieving, using a storage device, one or more digital twins of one or more geographical areas based on the one or more requests. Furthermore, the one or more digital twins include one or more digital representations of one or more real estate properties associated with the one or more geographical areas. Additionally, the method may include obtaining, using a processing device, one or more real estate data associated with the one or more real estate properties based on the one or more requests. Also, the method may include generating, using the processing device, one or more interactive representations of the one or more geographical areas based on the one or more digital twins and the one or more real estate data. Furthermore, the one or more interactive representations may include at least one information associated with the one or more real estate properties. Further, the method may include transmitting, using the communication device, the one or more interactive representations to the one or more user devices. Additionally, the method may include receiving, using the communication device, one or more inputs from the one or more user devices. Also, the method may include generating, using the processing device, one or more exploring parameters for exploring the one or more interactive representations based on the one or more inputs. Further, the method may include transmitting, using the communication device, the one or more exploring parameters to the one or more user devices. Furthermore, the one or more user devices may be configured for rendering the exploring of the one or more interactive representations for the one or more users based on the one or more exploring parameters and the one or more interactive representations.

The present disclosure provides a system for facilitating interactive search and discovery of real estate properties. Also, the system may include a communication device. Accordingly, the communication device may be configured for receiving one or more requests from one or more user devices associated with one or more users. Further, the communication device may be configured for transmitting the one or more interactive representations to the one or more user devices. Furthermore, the communication device may be configured for receiving one or more inputs from the one or more user devices. Additionally, the communication device may be configured for transmitting one or more exploring parameters to the one or more user devices. Moreover, the one or more user devices may be configured for rendering exploring the one or more interactive representations for the one or more users based on the one or more exploring parameters and the one or more interactive representations. Moreover, the system may include a storage device communicatively coupled with the communication device. Moreover, the storage device may be configured for retrieving one or more digital twins of one or more geographical areas based on the one or more requests. Moreover, the one or more digital twins may include one or more digital representations of one or more real estate properties associated with the one or more geographical areas. Also, the system may include a processing device communicatively coupled with the storage device. Further, the processing device may be configured for obtaining at least one real estate data associated with the at least one real estate property based on the at least one request. Further, the processing device may be configured for generating the one or more interactive representations of the one or more geographical areas based on the one or more digital twins and the one or more real estate data. Moreover, the one or more interactive representations further include at least one information associated with the one or more real estate properties. Additionally, the processing device may be configured for generating the one or more exploring parameters for the exploring of the one or more interactive representations based on the one or more inputs.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3A illustrates a flowchart of a method 300 of facilitating interactive search and discovery of real estate properties, in accordance with some embodiments.

FIG. 3B illustrates a continuation of the flowchart of the method 300 of facilitating interactive search and discovery of real estate properties, in accordance with some embodiments.

FIG. 4 illustrates a flowchart of a method 400 of facilitating interactive search and discovery of real estate properties, in accordance with some embodiments.

FIG. 5 illustrates a flowchart of a method 500 of facilitating interactive search and discovery of real estate properties, in accordance with some embodiments.

FIG. 6 illustrates a block diagram of a system 600 for facilitating interactive search and discovery of real estate properties, in accordance with some embodiments.

FIG. 7 illustrates a block diagram of the system 600 for facilitating interactive search and discovery of real estate properties, in accordance with some embodiments.

FIG. 8 illustrates a block diagram of the system 600 for facilitating interactive search and discovery of real estate properties, in accordance with some embodiments.

FIG. 9 is a screenshot of a user interface 900 of a software platform for facilitating interactive search and discovery of real estate properties, in accordance with some embodiments.

FIG. 10 is a screenshot of a user interface 1000 of the software platform for facilitating interactive search and discovery of real estate properties, in accordance with some embodiments.

FIG. 11 is a screenshot of a user interface 1100 of the software platform for facilitating interactive search and discovery of real estate properties, in accordance with some embodiments.

FIG. 12 is a screenshot of a user interface 1200 of the software platform for facilitating interactive search and discovery of real estate properties, in accordance with some embodiments.

FIG. 13 is a screenshot of a user interface 1300 of the software platform for facilitating interactive search and discovery of real estate properties, in accordance with some embodiments.

FIG. 14 is a screenshot of a user interface 1400 of the software platform for facilitating interactive search and discovery of real estate properties, in accordance with some embodiments.

FIG. 15 is a screenshot of a user interface 1500 of the software platform for facilitating interactive search and discovery of real estate properties, in accordance with some embodiments.

FIG. 16 is a screenshot of a user interface 1600 of the software platform for facilitating interactive search and discovery of real estate properties, in accordance with some embodiments.

FIG. 17 is a screenshot of a user interface 1700 of the software platform for facilitating interactive search and discovery of real estate properties, in accordance with some embodiments.

FIG. 18 is a screenshot of a user interface 1800 of the software platform for facilitating interactive search and discovery of real estate properties, in accordance with some embodiments.

FIG. 19 is a screenshot of a user interface 1900 of the software platform for facilitating interactive search and discovery of real estate properties, in accordance with some embodiments.

FIG. 20 is a screenshot of a user interface 2000 of a software platform for facilitating interactive search and discovery of real estate properties, in accordance with some embodiments.

FIG. 21 is a screenshot of a user interface 2100 of the software platform for facilitating interactive search and discovery of real estate properties, in accordance with some embodiments.

FIG. 22 is a screenshot of a user interface 2200 of the software platform for facilitating interactive search and discovery of real estate properties, in accordance with some embodiments.

FIG. 23 is a screenshot of a user interface 2300 of the software platform for facilitating interactive search and discovery of real estate properties, in accordance with some embodiments.

FIG. 24 is a screenshot of a user interface 2400 of the software platform for facilitating interactive search and discovery of real estate properties, in accordance with some embodiments.

FIG. 25 is a screenshot of a user interface 2500 of the software platform for facilitating interactive search and discovery of real estate properties, in accordance with some embodiments.

FIG. 26 is a screenshot of a user interface 2600 of the software platform for facilitating interactive search and discovery of real estate properties, in accordance with some embodiments.

FIG. 27 is a screenshot of a user interface 2700 of the software platform for facilitating interactive search and discovery of real estate properties, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview:

The present disclosure describes methods and systems of facilitating interactive search and discovery of real estate properties. Further, the present disclosure describes systems and methods facilitating interactively searching for real estate properties. Further, the disclosed system may include receiving a search request from a user. The search request may include a location. Further, the disclosed system may include providing a digital twin of the location to the user based on the search request. The digital twin includes multiple-level. The user may navigate the multiple levels of the digital twin by refining the search request by characterizing the location (adding location layers). The user is provided with multiple virtual real estate properties of actual real estate properties that may be available or proposed to be available in the location at a city level of the digital twin. Further, the disclosed system may allow the user to navigate the digital twin at a street level of the digital twin as an avatar and the user may be provided with pop-ups of information about virtual real estate properties at the street level based on the navigation. Virtual real estate properties correspond to actual real estate properties that are already built or proposed to be built. Further, the disclosed system may allow the user to select from one of the virtual real estate properties to enter that virtual real estate property virtually.

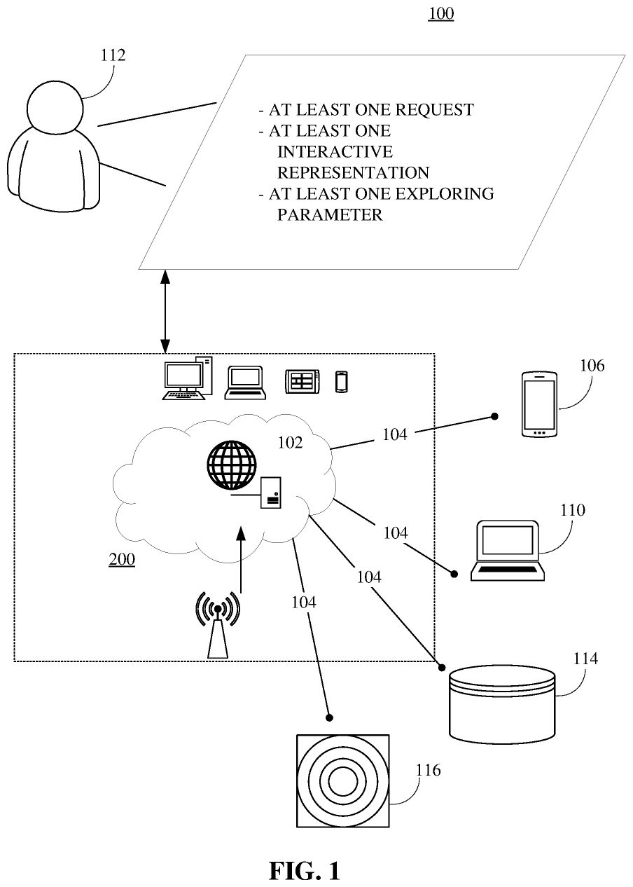

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

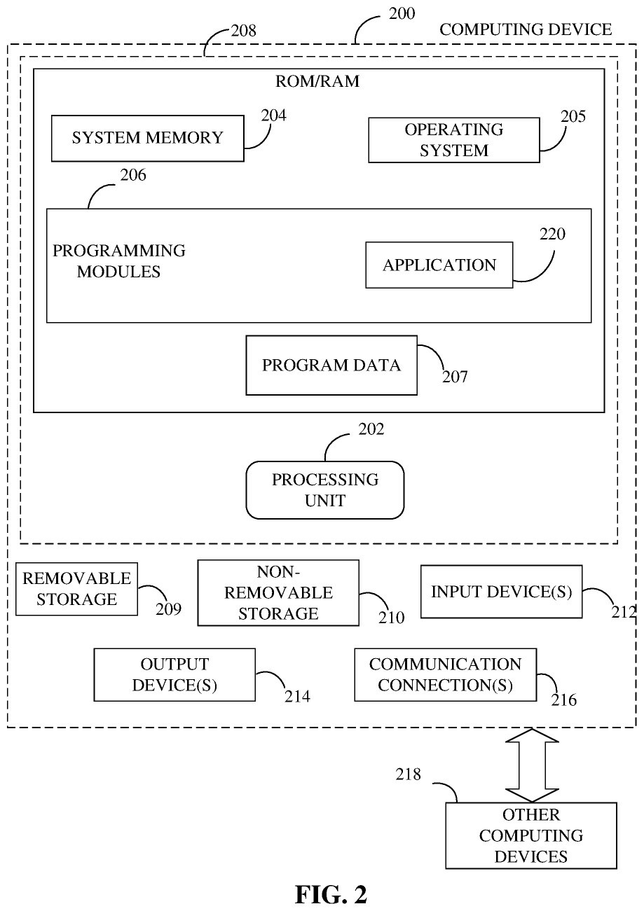

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable, and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD), or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

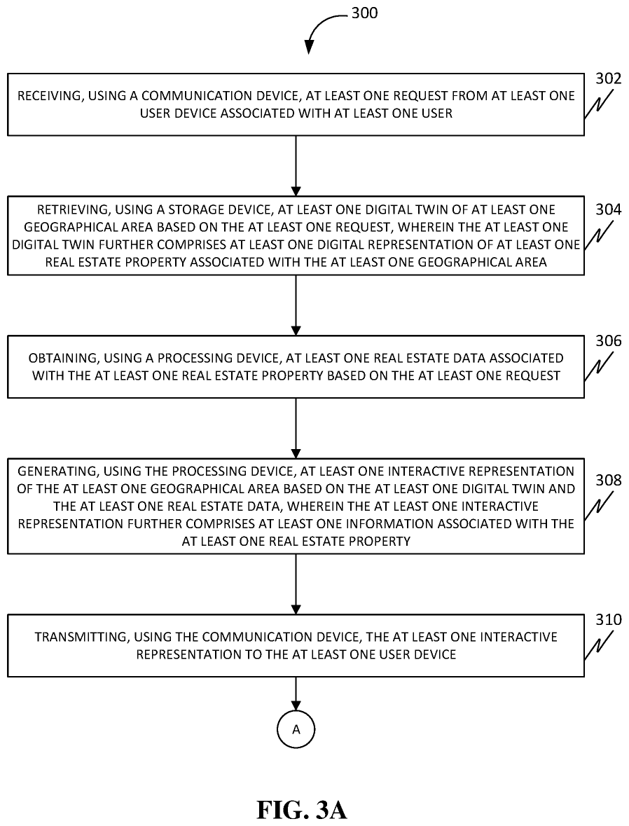

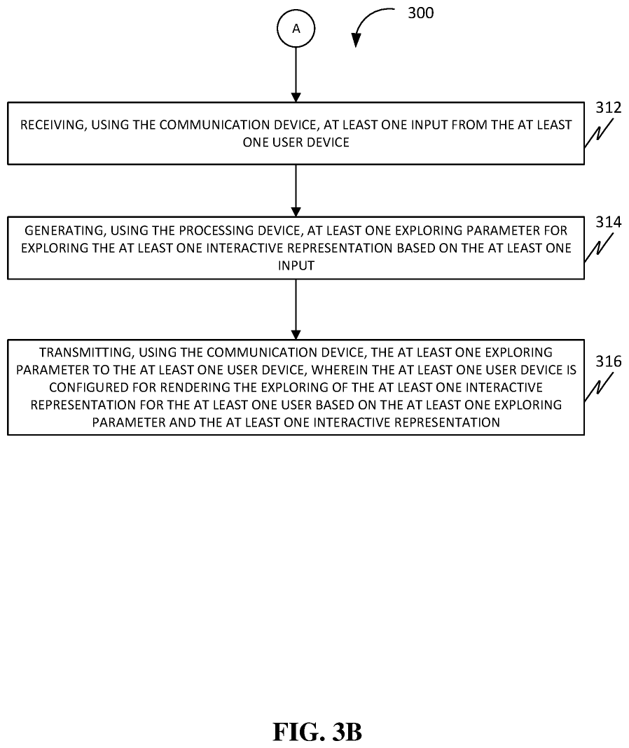

FIG. 3A and FIG. 3B illustrate a flowchart of a method 300 of facilitating interactive search and discovery of real estate properties, in accordance with some embodiments.

Accordingly, the method 300 may include a step 302 of receiving, using a communication device 602, one or more requests from one or more user devices associated with one or more users. Further, the one or more requests may include one or more geographical area identifiers. Further, the one or more user devices may include computing devices, client devices, etc. Further, the one or more users may include individuals, institutions, organizations, etc. Moreover, the method 300 may include a step 304 of retrieving, using a storage device 606, one or more digital twins of one or more geographical areas based on the one or more requests. Further, the one or more digital twins may be a digital representation and/or a virtual representation of the one or more geographical areas. Further, the one or more geographical areas may include cities, counties, towns, states, countries, regions, etc. Further, the one or more digital twins may include a digital representation and/or a virtual representation of a geographical area's infrastructure, a geographical area's utility, a geographical area's landmark, a geographical area's open space, a geographical area's public buildings (hotel, business hub, school, hospital, shopping center, etc), a geographical area's transport infrastructure, etc. Further, the one or more digital twins may include one or more layers of information. Further, the one or more layers of information may include a layer of traffic information associated with a traffic on roads associated with the one or more geographical areas. Further, the one or more layers of information may include a layer of people information associated with a movement of people in the one or more geographical areas. Further, the one or more layers of information may include a layer of environmental information associated with an environmental condition (air quality, water quality, soil quality, weather, etc.) of the one or more geographical areas. Further, the one or more layers of information may include a climate information of a climate (precipitation, wind, etc.) of the one or more geographical areas. Further, the one or more layers of information may include information about an environment of the one or more geographical areas over a period of a day. Further, the one or more layers of information may include an atmospheric information of an atmospheric condition (clear sky, overcast, etc.) of the one or more geographical areas. Further, in an embodiment, the retrieving of the one or more digital twins of the one or more geographical areas may include retrieving the one or more digital twins of the one or more geographical areas from a distributed ledger associated with a blockchain based on the one or more requests. Further, the one or more digital twins may be stored on the distributed ledger. Also, the one or more digital twins further include one or more digital representations of one or more real estate properties (projects) associated with the one or more geographical areas and one or more digital representations of one or more features of the one or more geographical areas. Further, the one or more features may include open spaces, transport infrastructure, public infrastructure, natural features (forest, hill, water bodies, etc.), traffic, etc. Further, the one or more digital representations may include virtual representations of the one or more real estate properties in one or more virtual environments (metaverse). Further, the one or more real estate properties may include real estate properties that may be constructed, partially constructed, or proposed to be constructed in the one or more geographical areas. Accordingly, the method 300 may include a step 306 of obtaining, using a processing device 604, one or more real estate data associated with the one or more real estate properties based on the one or more requests. Further, the one or more real estate data may include name, locations, listings, availability of units, construction status, floorplans, nearby landmarks, amenities, facilities, utilities, etc., associated with the one or more real estate properties. Furthermore, the method 300 may include a step 308 of generating, using the processing device 604, one or more interactive representations of the one or more geographical areas based on the one or more digital twins and the one or more real estate data. Further, the one or more interactive representations may be three-dimensional interactive representations, two-dimensional interactive representations, etc. Further, the one or more interactive representations may include the one or more digital representations of the one or more real estate properties. Also, the one or more interactive representations further include at least one information associated with the one or more real estate properties. Further, the at least one information may include name, listings, availability of units, nearby landmarks, amenities, facilities, utilities, etc., associated with the one or more real estate properties. Moreover, the method 300 may include a step 310 of transmitting, using the communication device 602, the one or more interactive representations to the one or more user devices. Further, the transmitting of the one or more interactive representations may include sending an interactive user interface and the one or more interactive representations on the one or more user devices for presenting the one or more interactive representations in the interactive user interface using the one or more user devices. Further, the interactive user interface may be a three-dimensional interactive user interface. Further, the interactive user interface may include digital and/or virtual buttons, search boxes, sliders, etc. Further, in an embodiment, the generating of the one or more inputs may be based on interacting with the digital and/or virtual buttons, the search boxes, the sliders, etc., by the one or more users using the one or more user devices. Further, in an embodiment, the transmitting of the one or more interactive representations may include transmitting at least a portion of the one or more interactive representations to the one or more user devices. Further, in an embodiment, the method 300 may include detecting, using the processing device, a bandwidth of a network connection associated with the one or more user devices based on the one or more requests. Further, the method 300 may include determining, using the processing device, a portion of the one or more interactive representations that is to be transmitted based on the bandwidth. Further, the transmitting of the one or more interactive representations may include transmitting the portion of the one or more interactive representations to the one or more user devices. Accordingly, the method 300 may include a step 312 of receiving, using the communication device 602, one or more inputs from the one or more user devices. Further, the one or more user devices may include input devices for generating the one or more inputs based on receiving one or more input actions from the one or more users. Further, the one or more input actions may include utterances, gestures, expressions, movements, etc. Furthermore, the method 300 may include a step 314 of generating, using the processing device 604, one or more exploring parameters for exploring the one or more interactive representations based on the one or more inputs. Further, the one or more exploring parameters may include a viewing perspective, a viewing location, a viewing angle, a viewing position, a viewing orientation, an environmental factor (morning, afternoon, evening, night, etc.), etc., associated with the one or more interactive representations. Further, the exploring may include viewing, experiencing, navigating, etc. Moreover, the method 300 may include a step 316 of transmitting, using the communication device 602, the one or more exploring parameters to the one or more user devices. Also, the one or more user devices may be configured for rendering the exploring of the one or more interactive representations for the one or more users based on the one or more exploring parameters and the one or more interactive representations. Further, the rendering may include presenting, provisioning, providing, walking through, etc. Further, in an embodiment, the rendering of the exploring of the one or more interactive representations for the one or more users may include rendering viewing of the one or more interactive representations from at least one view perspective. Further, the at least one view perspective may include a first person view, a third person view, etc.

Further, in an embodiment, the one or more user devices may be one or more mixed reality devices (mixed reality headsets, mixed reality glasses, etc.). Further, the one or more mixed reality devices may be configured for rendering the exploring of the one or more interactive representations for the one or more users in a mixed reality environment based on the one or more exploring parameters and the one or more interactive representations. Further, the one or more inputs may correspond to at least one of a movement of the one or more users on a path (real life street), a gesture of the one or more users, etc. Further, the one or more mixed reality devices captures at least one of the movement of the one or more user on the path, the gesture of the one or more users, etc. to generate the one or more inputs. Further, the rendering of the exploring of the one or more interactive representations for the one or more users in the mixed reality environment may be further based on at least one of the movement of the one or more users on the path, the gesture of the one or more users, etc.

In some embodiments, the method 300 may include generating, using the processing device 604, one or more avatars of the one or more users in the one or more interactive representations. Further, the one or more avatars may include digital representations and/or virtual representations of the one or more users. Furthermore, the one or more exploring parameters further include one or more navigational parameters for navigating the one or more avatars to one or more locations in the one or more interactive representations. Further, the one or more navigational parameters may include a direction of movement, an amount of movement, etc. Furthermore, the one or more user devices may be configured for rendering the navigating of the one or more avatars to the one or more locations in the one or more interactive representations. Furthermore, the one or more avatars may be associated with one or more view perspectives based on the navigating. Furthermore, the rendering of the exploring may be based on the one or more view perspectives. Further, the one or more view perspectives may include a view angle, a view direction, a view position, a view orientation, etc. Further, the one or more view perspectives may include a first person view.

In some embodiments, the method 300 may further include populating, using the processing device 604, the one or more digital twins with one or more first avatars based on the one or more digital twins. Further, the populating may include generating the one or more first avatars in the one or more digital twins. Also, the generating of the one or more interactive representations may be further based on the populating. Also, the one or more first avatars provide responses to queries directed to the one or more first avatars. Further, in an embodiment, the one or more first avatars may be digital representations and/or virtual representations of one or more first users. Further, the one or more first users may include individuals digitally and/or virtually present in the one or more geographical areas. Further, in an embodiment, the one or more first avatars may be digital representations and/or virtual representations of digitally and/or virtually created beings. Further, in an embodiment, the at least one first avatar provides the responses to the queries directed to the at least one first avatar based on location intelligence. Further, the location intelligence may include performing a location analysis and a behavioral analysis on a location information corresponding to a location associated with at least one of the at least one first avatar and the at least one avatar in the one or more digital twins.

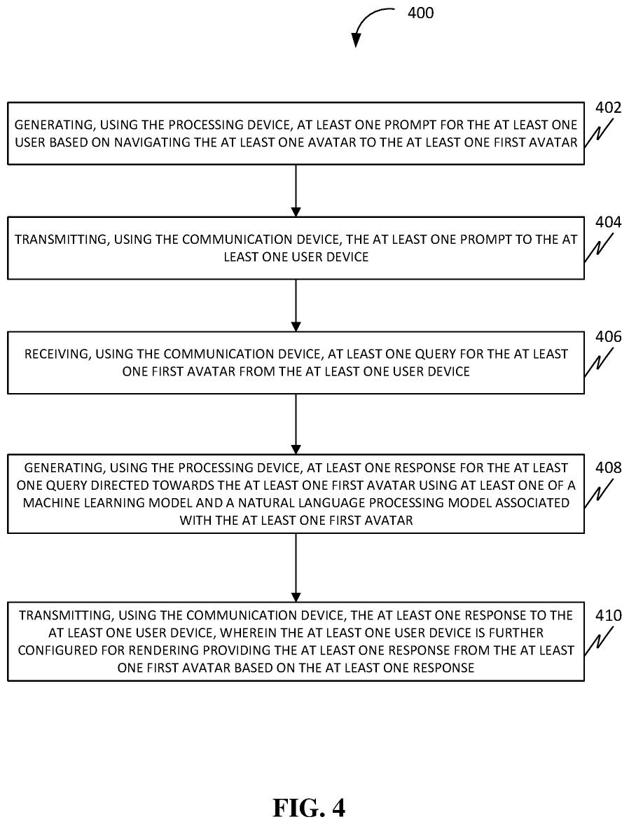

FIG. 4 illustrates a flowchart of a method 400 of facilitating interactive search and discovery of real estate properties, in accordance with some embodiments.

Additionally, the one or more avatars navigate to the one or more first avatars based on the one or more navigational parameters. Accordingly, the method 400 further may include a step 402 of generating, using the processing device 604, one or more prompts for the one or more users based on navigating the one or more avatars to the one or more first avatars. Further, the one or more prompts may prompt the one or more users to direct the queries to the one or more first avatars. Accordingly, the method 400 further may include a step 404 of transmitting, using the communication device 602, the one or more prompts to the one or more user devices. Accordingly, the method 400 further may include a step 406 of receiving, using the communication device 602, one or more queries for the one or more first avatars from the one or more user devices. Accordingly, the method 400 further may include a step 408 of generating, using the processing device 604, one or more responses for the one or more queries directed towards the one or more first avatars using one or more of a machine learning model and a natural language processing model associated with the one or more first avatars. Further, one or more of the machine learning model and the natural language processing model may be associated with a software application associated with the one or more first avatars. Further, the software application may include ChatGPT™. Accordingly, the method 400 further may include a step 410 of transmitting, using the communication device 602, the one or more responses to the one or more user devices. Accordingly, the one or more user devices may be configured for rendering providing the one or more responses from the one or more first avatars based on the one or more responses.

In some embodiments, each of the one or more first avatars may be associated with a role. Further, the role may include a bystander, a worker, a pedistrian, an owner, a shopkeeper, a tourist, etc. associated with the one or more geographical areas. Additionally, the role characterizes each of the one or more first avatars. Further, the characterizing of the one or more first avatars may include defining a persona, an appearance, a movement, a position, a location, etc., of the one or more first avatars associated with the one or more real estate properties. Additionally, the generating of the one or more responses for the one or more queries directed towards the one or more first avatars may be further based on the role of each of the one or more first avatars.

In some embodiments, the method 400 may further include generating, using the processing device 604, one or more navigational data associated with the navigation of the one or more avatars to the one or more locations in the one or more interactive representations. Further, the one or more navigational data may include one or more previous locations in the one or more interactive representations, one or more previous positions in one or more interactive representations, etc. Accordingly, the generating of the one or more responses may be further based on the one or more navigational data.

In some embodiments, the one or more user devices include one or more sensors (such as one or more sensors 704). Further, the one or more sensors may include imaging sensors (cameras), motion sensors, eye tracking sensors, microphones, physiological sensors, etc. Additionally, the one or more sensors may be further configured for generating one or more contextual information associated with the one or more queries based on detecting one or more of a verbal cue and a nonverbal cue associated with the one or more users. Further, the verbal cue may include an utterance. Further, the nonverbal cue may include an expression, a gesture, a physiological state, an emotional state, etc. Further, the one or more contextual information may include one or more of the verbal cue and the nonverbal cue. Additionally, the generating of the one or more responses may be further based on the one or more contextual information.

In some embodiments, the one or more user devices include one or more input sensors (such as one or more input sensors 802). Further, the one or more input sensors may include imaging sensors (cameras), motion sensors, eye tracking sensors, microphones, etc. Accordingly, the one or more input sensors may be further configured for generating the one or more input sensor data based on detecting one or more of a gesture, a movement, and an expression of the one or more users. Accordingly, the one or more inputs further comprise the one or more input sensor data.

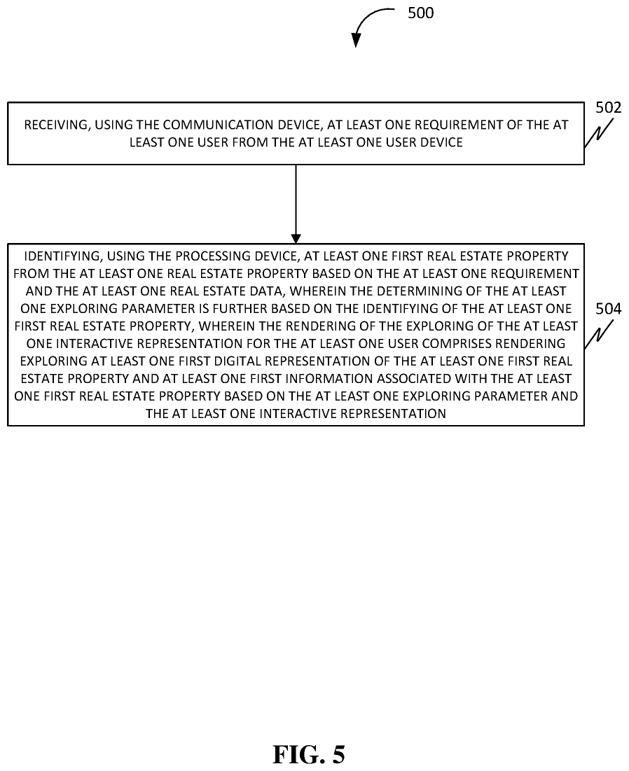

FIG. 5 illustrates a flowchart of a method 500 of facilitating interactive search and discovery of real estate properties, in accordance with some embodiments.

Moreover, the method 500 further may include a step 502 of receiving, using the communication device 602, one or more requirements of the one or more users from the one or more user devices. Further, the one or more requirements may include one or more characteristics of units in the real estate properties required by the one or more users. Further, the one or more characteristics may include an area (sq. ft., sq.m, etc.), a number of rooms, a type of room, an amenity, a facility, etc. Further, the one or more requirements act as one or more filters for filtering the real estate properties. Further, the one or more requirements may include a requirement of one or more surrounding views from a real estate property, a requirement of a view corresponding to a direction from the real estate property, a requirement of one or more types of a traffic in roads associated with the real estate property, a requirement of one or more climatic conditions associated with the real estate property, a requirement of one or more environmental conditions associated with the real estate property, etc. Accordingly, the method 500 further may include a step 504 of identifying, using the processing device 604, one or more first real estate properties from the one or more real estate properties based on the one or more requirements and the one or more real estate data. Further, the determining of the one or more exploring parameters may be based on the identifying of the one or more first real estate properties. Further, the rendering of the exploring of the one or more interactive representations for the one or more users includes rendering exploring one or more first digital representations of the one or more first real estate properties and one or more first information associated with the one or more first real estate properties based on the one or more exploring parameters and the one or more interactive representations.

In some embodiments, the obtaining further includes obtaining the one or more real estate data from one or more external devices. Further, the one or more external devices may include computing devices, client devices, etc. Moreover, the one or more external devices may be configured for generating the one or more real estate data in real time. Further, in an embodiment, the one or more external devices may include sensors for detecting a status of the one or more real estate properties in the real time. Further, the generating of the one or more real estate data may be based on the detecting. Further, the status may include a vacancy of units in the one or more real estate properties, a number of for-sale units in the one or more real estate properties, a number of for-rent units in the one or more real estate properties, a price of units in the one or more real estate properties, etc.

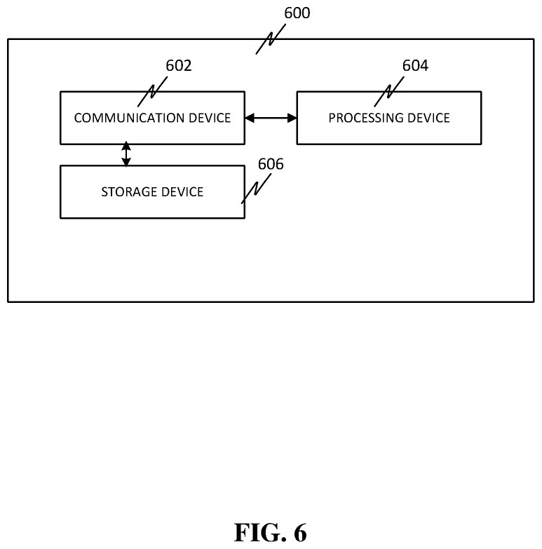

FIG. 6 illustrates a block diagram of a system 600 of facilitating interactive search and discovery of real estate properties, in accordance with some embodiments.

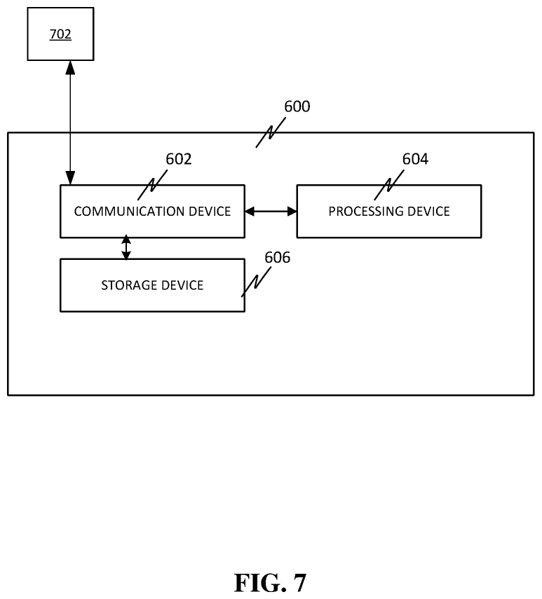

Accordingly, the system 600 may include a communication device 602. Furthermore, the communication device 602 may be configured for receiving one or more requests from one or more user devices 702 (as shown in FIG. 7) associated with one or more users. Additionally, the communication device 602 may be configured for transmitting the one or more interactive representations to the one or more user devices 702. Moreover, the communication device 602 may be configured for receiving one or more inputs from the one or more user devices 702. Also, the communication device 602 may be configured for transmitting one or more exploring parameters to the one or more user devices 702. Accordingly, the one or more user devices 702 may be configured for rendering exploring the one or more interactive representations for the one or more users based on the one or more exploring parameters and the one or more interactive representations. Accordingly, the system 600 a storage device 606 communicatively coupled with the communication device 602. Accordingly, the storage device 606 may be configured for retrieving one or more digital twins of one or more geographical areas based on the one or more requests. Accordingly, the one or more digital twins further include one or more digital representations of one or more real estate properties associated with the one or more geographical areas. Further, the system 600 may include a processing device 604 communicatively coupled with the storage device 606. Further, the processing device 604 may be configured for obtaining at least one real estate data associated with the at least one real estate property based on the at least one request. Additionally, the processing device 604 may be configured for generating the one or more interactive representations of the one or more geographical areas based on the one or more digital twins and the one or more real estate data. Accordingly, the one or more interactive representations further include at least one information associated with the one or more real estate properties. Also, the processing device 604 may be configured for generating the one or more exploring parameters for the exploring of the one or more interactive representations based on the one or more inputs.

In some embodiments, the processing device 604 may be further configured for generating one or more avatars of the one or more users in the one or more interactive representations. Additionally, the one or more exploring parameters further include one or more navigational parameters for navigating the one or more avatars to one or more locations in the one or more interactive representations. Additionally, the one or more user devices 702 may be further configured for rendering the navigating of the one or more avatars to the one or more locations in the one or more interactive representations. Additionally, the one or more avatars may be associated with one or more view perspectives based on the navigating. Additionally, the rendering of the exploring may be further based on the one or more view perspectives.

In some embodiments, the processing device 604 may be further configured for populating the one or more digital twins with one or more first avatars based on the one or more digital twins. Accordingly, the generating of the one or more interactive representations may be further based on the populating. Accordingly, the one or more first avatars provide responses to queries directed to the one or more first avatars.

Moreover, the one or more avatars navigate to the one or more first avatars based on the one or more navigational parameters. Moreover, the processing device 604 may be further configured for generating one or more prompts for the one or more users based on navigating the one or more avatars to the one or more first avatars. Moreover, the processing device 604 may be further configured for generating one or more responses for one or more queries directed towards the one or more first avatars using one or more of a machine learning model and a natural language processing model associated with the one or more first avatars. Further, the communication device 602 may be configured for receiving the one or more queries for the one or more first avatars from the one or more user devices 702. Moreover, the communication device 602 may be further configured for transmitting the one or more responses to the one or more user devices 702. Moreover, the one or more user devices 702 may be configured for rendering providing the one or more responses from the one or more first avatars based on the one or more responses.

In some embodiments, each of the one or more first avatars may be associated with a role. Further, the role characterizes each of the one or more first avatars. Further, the generating of the one or more responses for the one or more queries directed towards the one or more first avatars may be based on the role of each of the one or more first avatars.

In some embodiments, the processing device 604 may be further configured for generating one or more navigational data associated with the navigation of the one or more avatars to the one or more locations in the one or more interactive representations. Moreover, the generating of the one or more responses may be further based on the one or more navigational data.

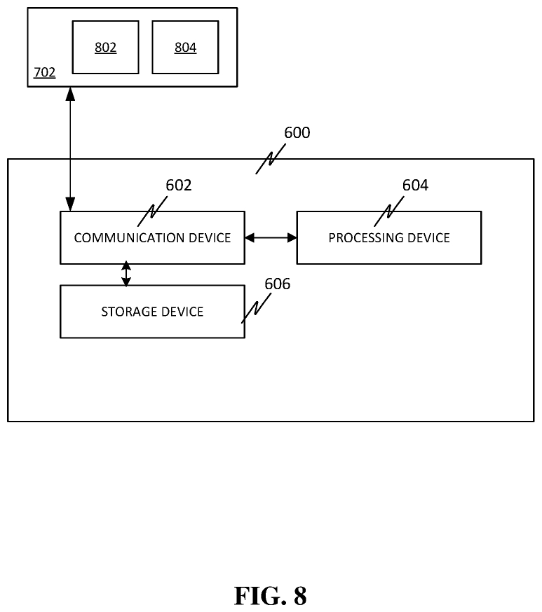

In some embodiments, the one or more user devices 702 includes one or more sensors 804 (as shown in FIG. 8). Further, the one or more sensors 804 may be configured for generating one or more contextual information associated with the one or more queries based on detecting one or more of a verbal cue and a nonverbal cue associated with the one or more users. Further, the generating of the one or more responses may be based on the one or more contextual information.

In some embodiments, the one or more user devices 702 includes one or more input sensors 802 (as shown in FIG. 8). Moreover, the one or more input sensors 802 may be configured for generating the one or more input sensor data based on detecting one or more of a gesture, a movement, and an expression of the one or more users. Moreover, the one or more inputs further comprise the one or more input sensor data.

In some embodiments, the communication device 602 may be further configured for receiving one or more requirements of the one or more users from the one or more user devices 702. Further, the processing device 604 may be configured for identifying one or more first real estate properties from the one or more real estate properties based on the one or more requirements and the one or more real estate data. Further, the determining of the one or more exploring parameters may be based on the identifying of the one or more first real estate properties. Further, the rendering of the exploring of the one or more interactive representations for the one or more users includes rendering exploring one or more first digital representations of the one or more first real estate properties and one or more first information associated with the one or more first real estate properties based on the one or more exploring parameters and the one or more interactive representations.

In some embodiments, the obtaining further includes obtaining the one or more real estate data from one or more external devices. Moreover, the one or more external devices may be configured for generating the one or more real estate data in real time.

FIG. 7 illustrates a block diagram of the system 600 of facilitating interactive search and discovery of real estate properties, in accordance with some embodiments.

FIG. 8 illustrates a block diagram of the system 600 of facilitating interactive search and discovery of real estate properties, in accordance with some embodiments.

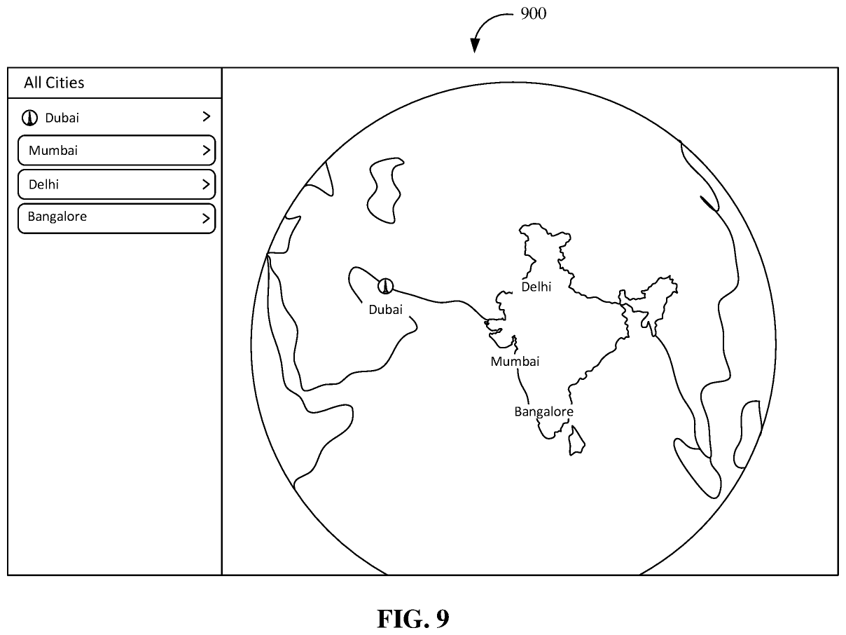

FIG. 9 is a screenshot of a user interface 900 of a software platform for facilitating interactive search and discovery of real estate properties, in accordance with some embodiments.

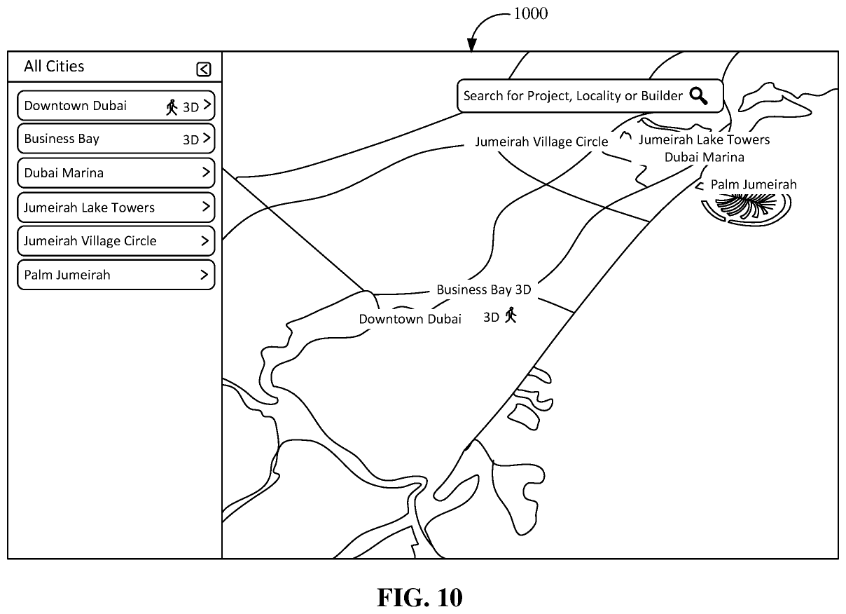

FIG. 10 is a screenshot of a user interface 1000 of the software platform for facilitating interactive search and discovery of real estate properties, in accordance with some embodiments.

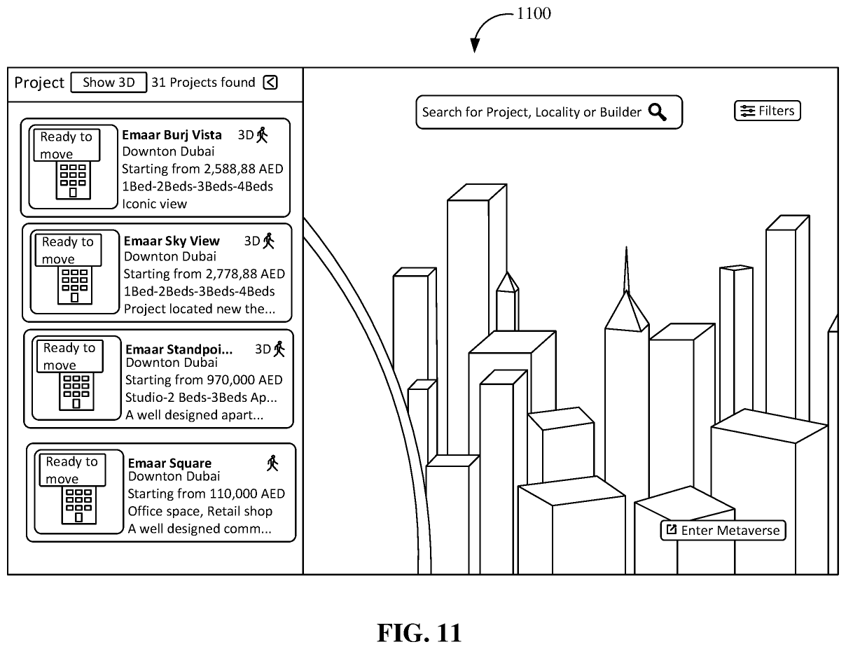

FIG. 11 is a screenshot of a user interface 1100 of the software platform for facilitating interactive search and discovery of real estate properties, in accordance with some embodiments.

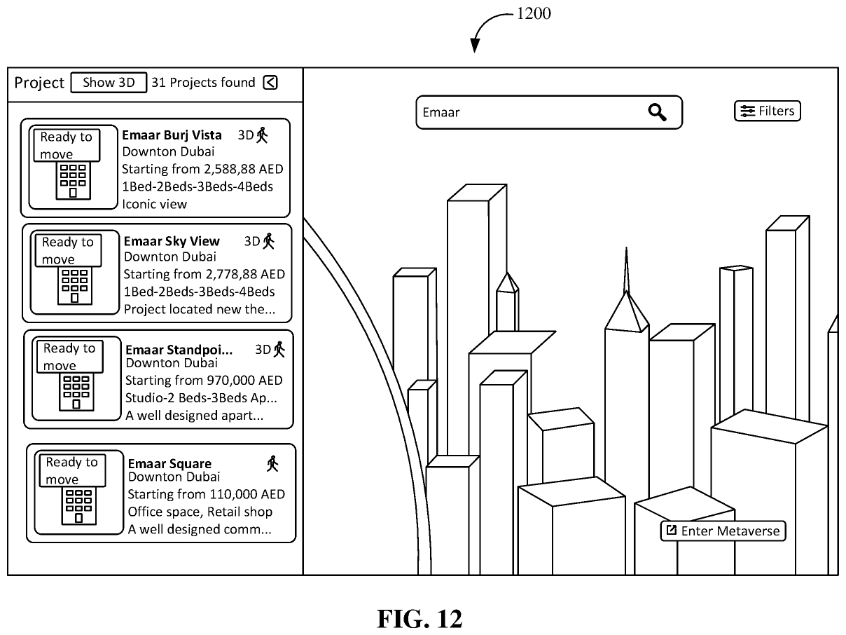

FIG. 12 is a screenshot of a user interface 1200 of the software platform for facilitating interactive search and discovery of real estate properties, in accordance with some embodiments.

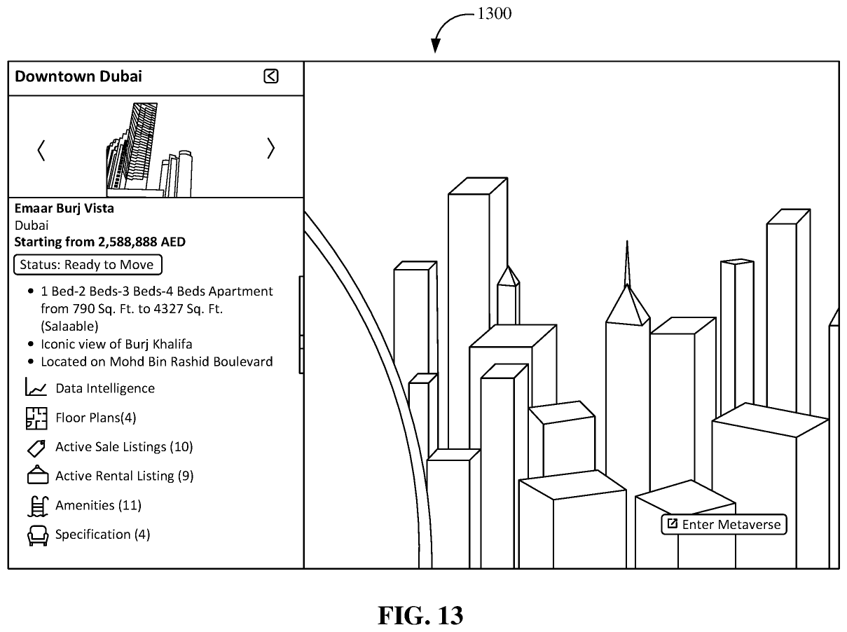

FIG. 13 is a screenshot of a user interface 1300 of the software platform for facilitating interactive search and discovery of real estate properties, in accordance with some embodiments.

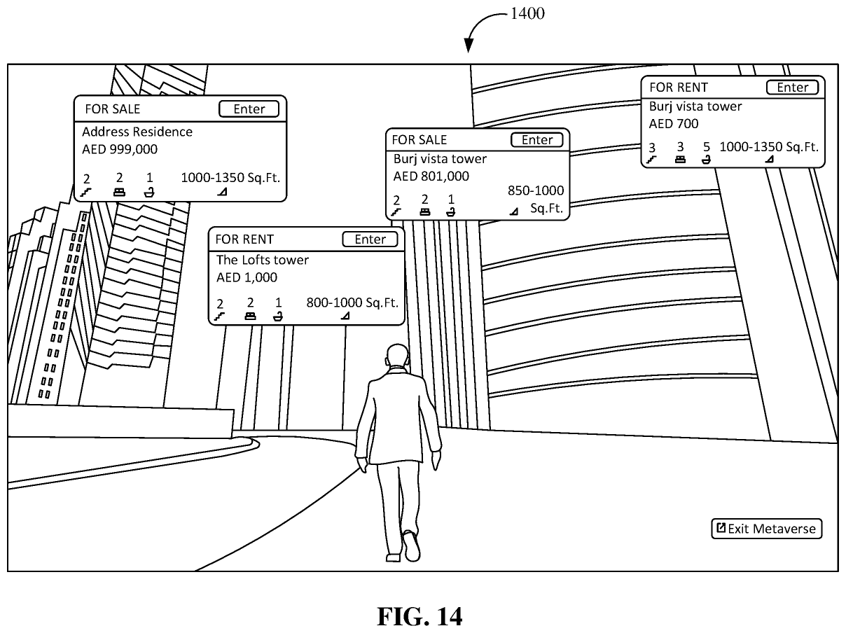

FIG. 14 is a screenshot of a user interface 1400 of the software platform for facilitating interactive search and discovery of real estate properties, in accordance with some embodiments.

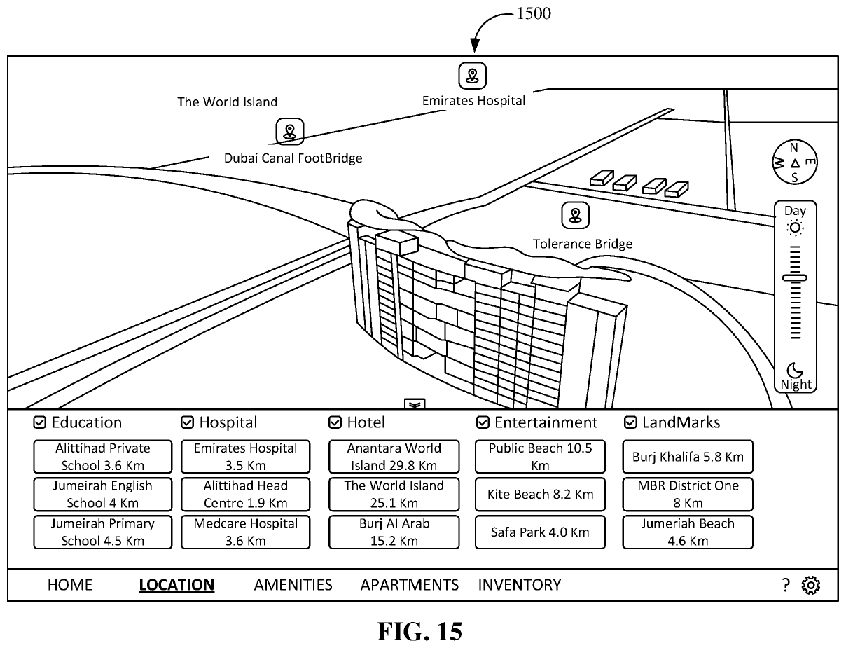

FIG. 15 is a screenshot of a user interface 1500 of the software platform for facilitating interactive search and discovery of real estate properties, in accordance with some embodiments.

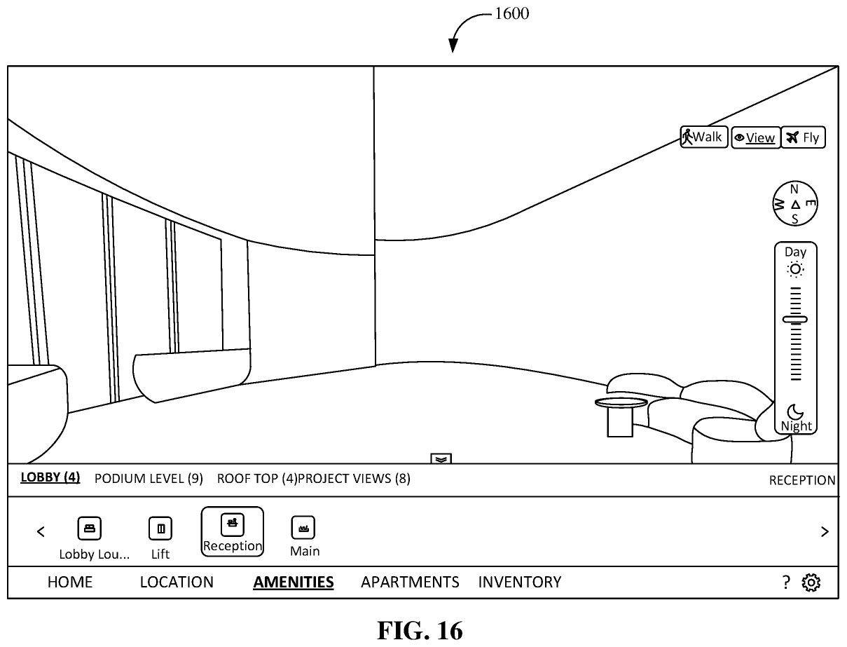

FIG. 16 is a screenshot of a user interface 1600 of the software platform for facilitating interactive search and discovery of real estate properties, in accordance with some embodiments.

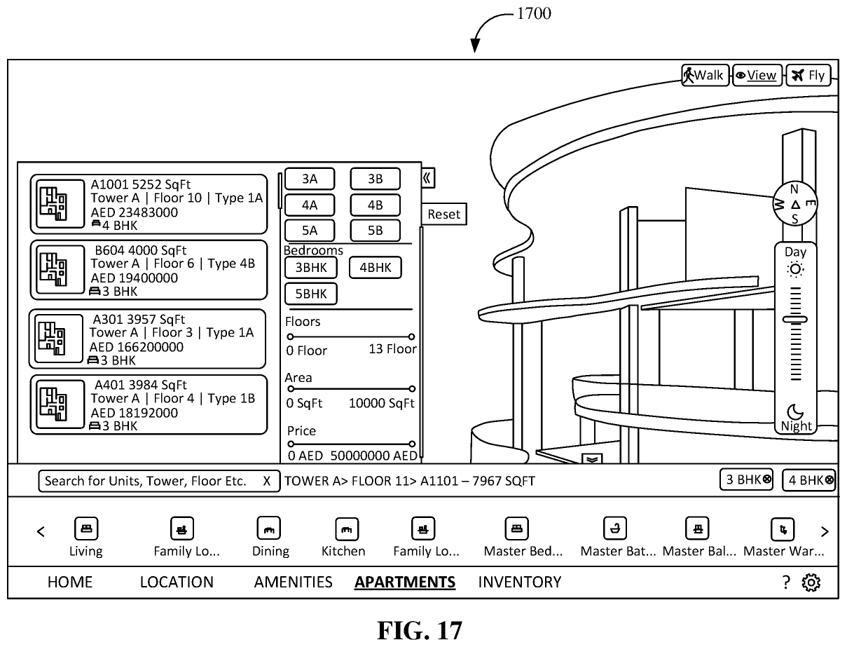

FIG. 17 is a screenshot of a user interface 1700 of the software platform for facilitating interactive search and discovery of real estate properties, in accordance with some embodiments.

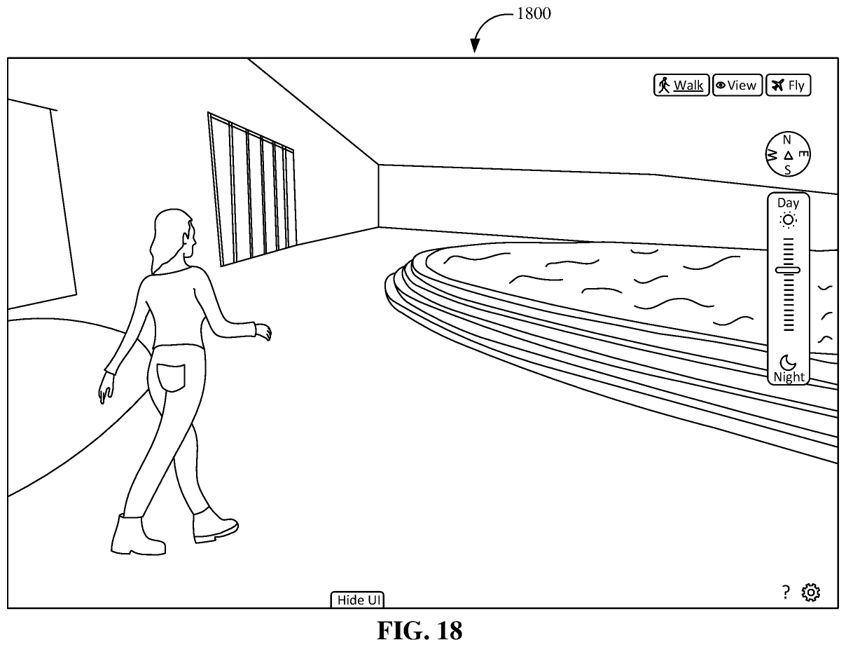

FIG. 18 is a screenshot of a user interface 1800 of the software platform for facilitating interactive search and discovery of real estate properties, in accordance with some embodiments.

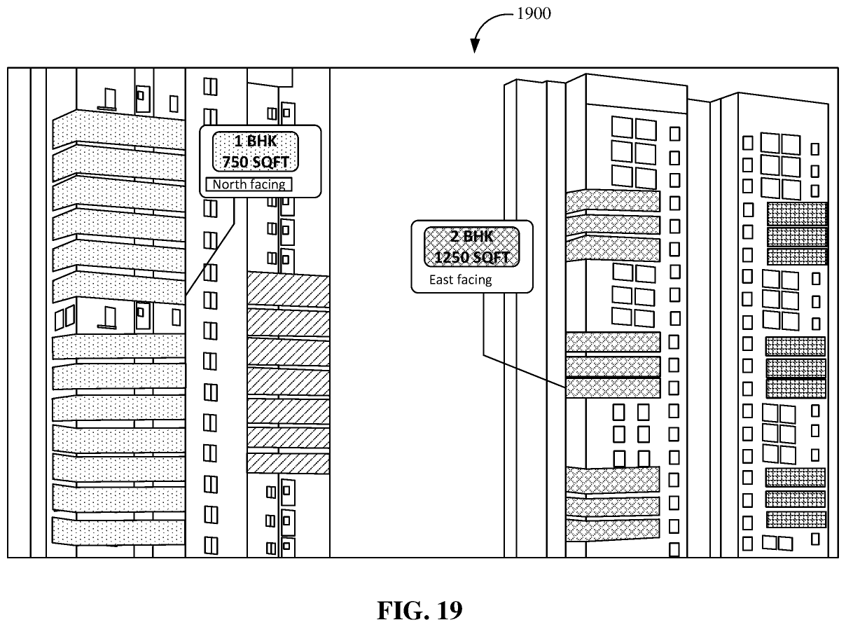

FIG. 19 is a screenshot of a user interface 1900 of the software platform for facilitating interactive search and discovery of real estate properties, in accordance with some embodiments.

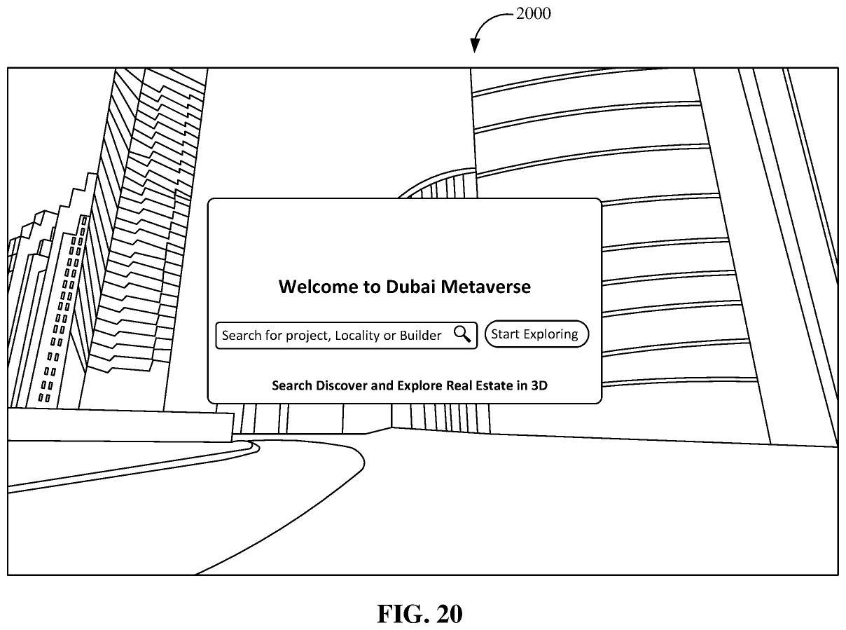

FIG. 20 is a screenshot of a user interface 2000 of a software platform for facilitating interactive search and discovery of real estate properties, in accordance with some embodiments.

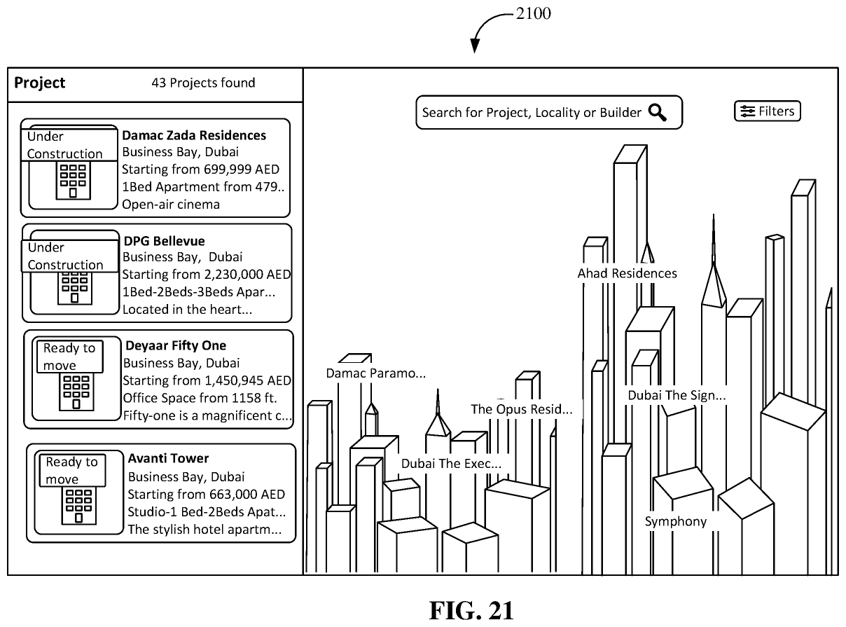

FIG. 21 is a screenshot of a user interface 2100 of the software platform for facilitating interactive search and discovery of real estate properties, in accordance with some embodiments.

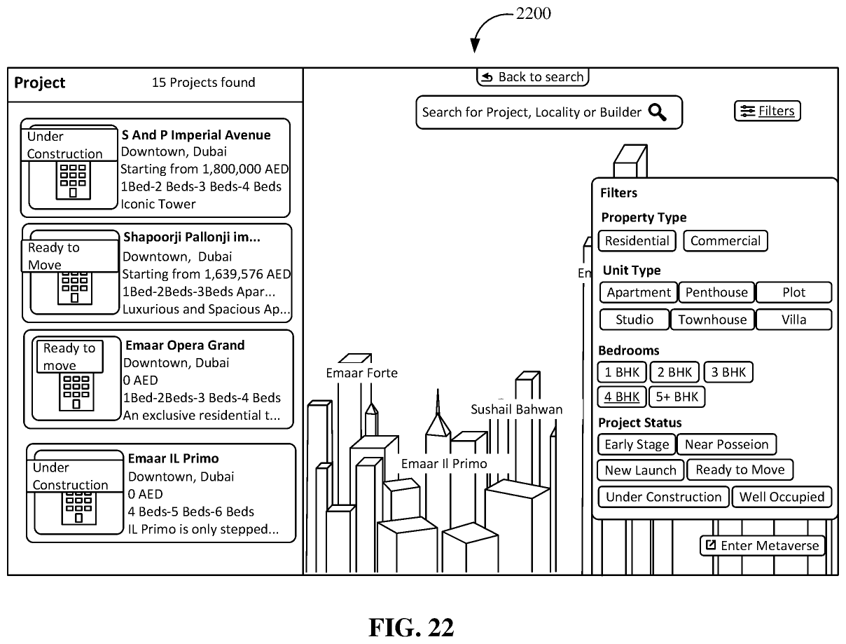

FIG. 22 is a screenshot of a user interface 2200 of the software platform for facilitating interactive search and discovery of real estate properties, in accordance with some embodiments.

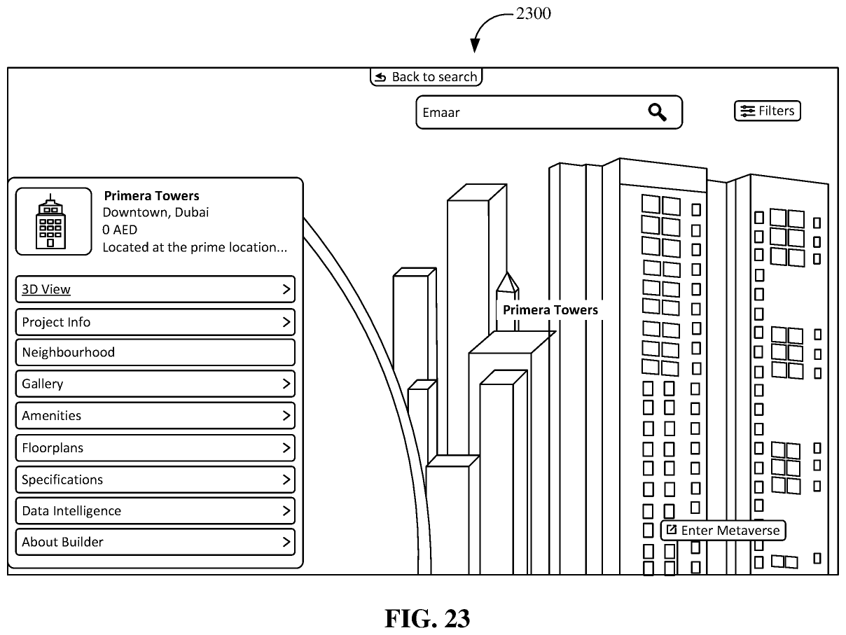

FIG. 23 is a screenshot of a user interface 2300 of the software platform for facilitating interactive search and discovery of real estate properties, in accordance with some embodiments.

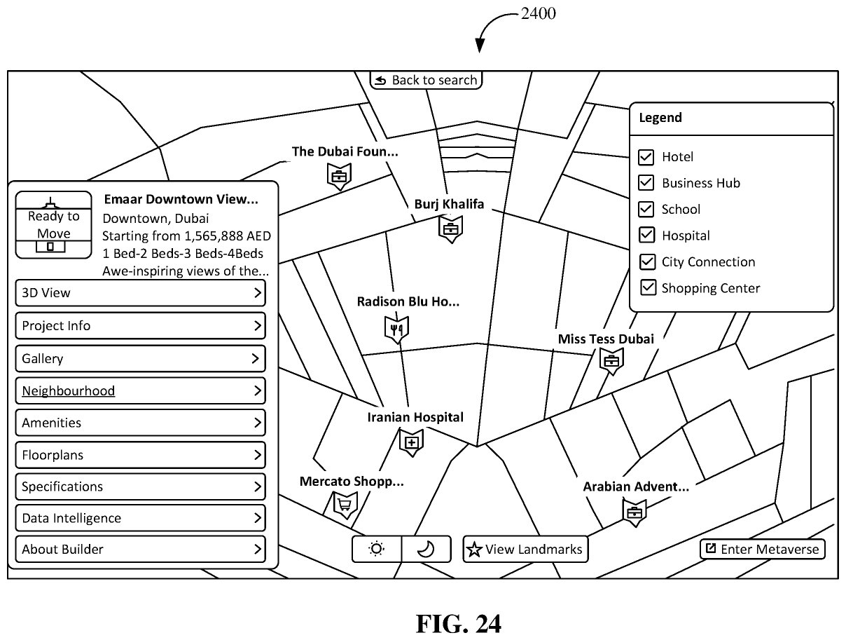

FIG. 24 is a screenshot of a user interface 2400 of the software platform for facilitating interactive search and discovery of real estate properties, in accordance with some embodiments.

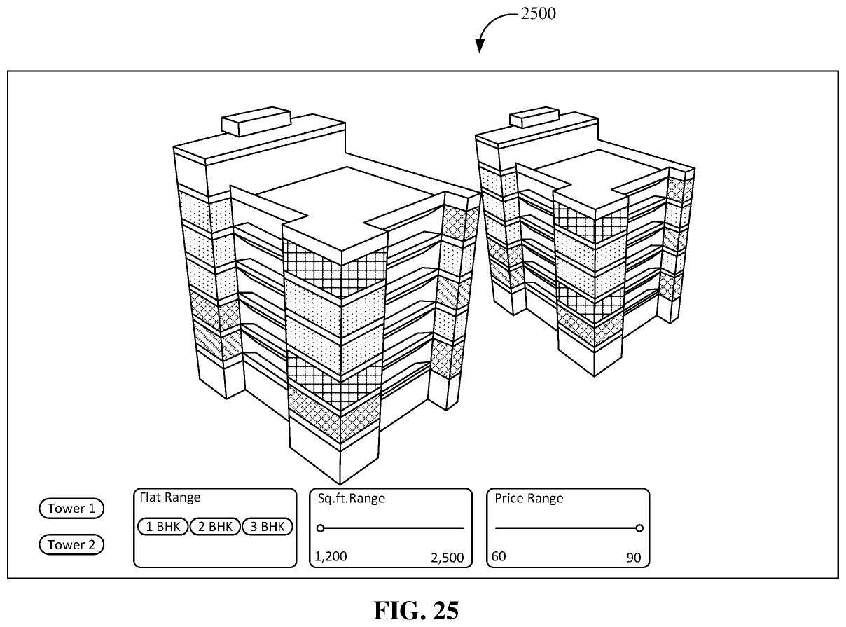

FIG. 25 is a screenshot of a user interface 2500 of the software platform for facilitating interactive search and discovery of real estate properties, in accordance with some embodiments.

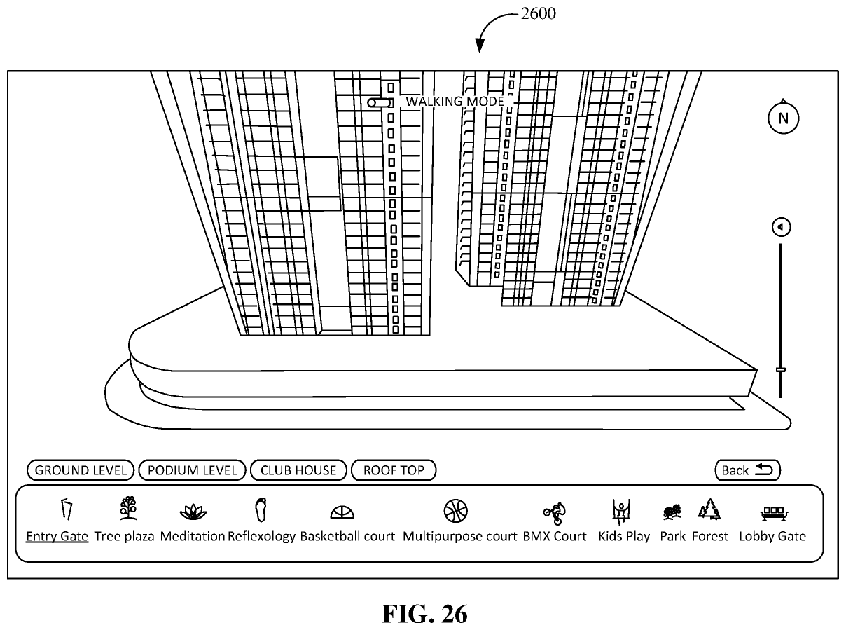

FIG. 26 is a screenshot of a user interface 2600 of the software platform for facilitating interactive search and discovery of real estate properties, in accordance with some embodiments.

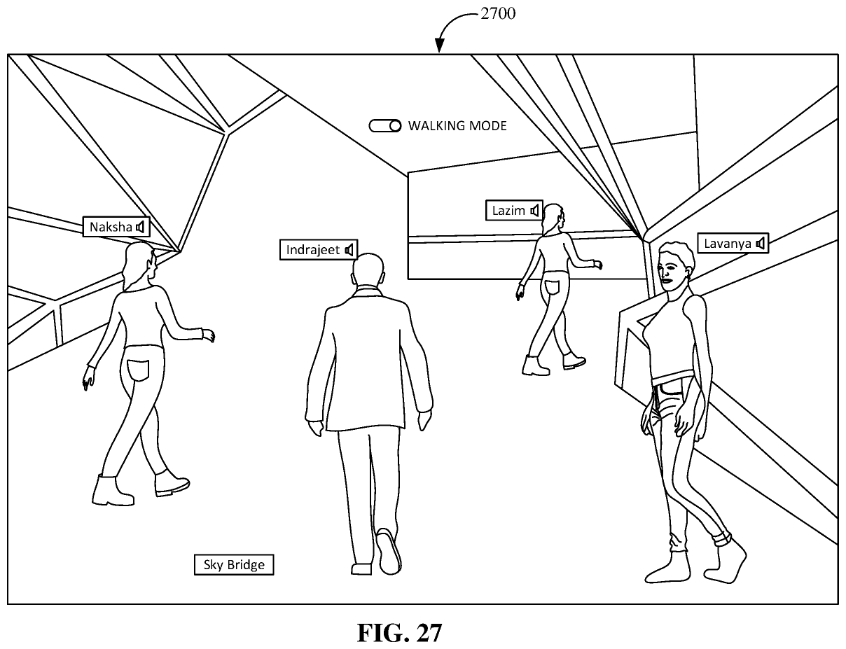

FIG. 27 is a screenshot of a user interface 2700 of the software platform for facilitating interactive search and discovery of real estate properties, in accordance with some embodiments.

Although the invention has been explained in relation to its preferred embodiment, it is to be understood that many other possible modifications and variations can be made without departing from the spirit and scope of the invention as hereinafter claimed.

What is claimed is:

1. A method of facilitating interactive search and discovery of real estate properties, wherein the method comprises:
receiving, using a communication device, at least one request from at least one user device associated with at least one user;
retrieving, using a storage device, at least one digital twin of at least one geographical area based on the at least one request, wherein the at least one digital twin further comprises at least one digital representation of at least one real estate property associated with the at least one geographical area;
obtaining, using a processing device, at least one real estate data associated with the at least one real estate property based on the at least one request;
generating, using the processing device, at least one interactive representation of the at least one geographical area based on the at least one digital twin and the at least one real estate data, wherein the at least one interactive representation further comprises at least one information associated with the at least one real estate property;
transmitting, using the communication device, the at least one interactive representation to the at least one user device;
receiving, using the communication device, at least one input from the at least one user device;
generating, using the processing device, at least one exploring parameter for exploring the at least one interactive representation based on the at least one input; and
transmitting, using the communication device, the at least one exploring parameter to the at least one user device, wherein the at least one user device is configured for rendering the exploring of the at least one interactive representation for the at least one user based on the at least one exploring parameter and the at least one interactive representation.

2. The method of claim 1 further comprising generating, using the processing device, at least one avatar of the at least one user in the at least one interactive representation, wherein the at least one exploring parameter further comprises at least one navigational parameter for navigating the at least one avatar to at least one location in the at least one interactive representation, wherein the at least one user device is further configured for rendering the navigating of the at least one avatar to the at least one location in the at least one interactive representation, wherein the at least one avatar is associated with at least one view perspective based on the navigating, wherein the rendering of the exploring is further based on the at least one view perspective.

3. The method of claim 2 further comprising populating, using the processing device, the at least one digital twin with at least one first avatar based on the at least one digital twin, wherein the generating of the at least one interactive representation is further based on the populating, wherein the at least one first avatar provides responses to queries directed to the at least one first avatar.

4. The method of claim 3 wherein the at least one avatar navigates to the at least one first avatar based on the at least one navigational parameter, wherein the method further comprises:
generating, using the processing device, at least one prompt for the at least one user based on navigating the at least one avatar to the at least one first avatar;
transmitting, using the communication device, the at least one prompt to the at least one user device;
receiving, using the communication device, at least one query for the at least one first avatar from the at least one user device;
generating, using the processing device, at least one response for the at least one query directed towards the at least one first avatar using at least one of a machine learning model and a natural language processing model associated with the at least one first avatar; and
transmitting, using the communication device, the at least one response to the at least one user device, wherein the at least one user device is further configured for rendering providing the at least one response from the at least one first avatar based on the at least one response.

5. The method of claim 4 wherein each of the at least one first avatar is associated with a role, wherein the role characterizes each of the at least one first avatar, wherein the generating of the at least one response for the at least one query directed towards the at least one first avatar is further based on the role of each of the at least one first avatar.

6. The method of claim 4 further comprises generating, using the processing device, at least one navigational data associated with the navigation of the at least one avatar to the at least one location in the at least one interactive representation, wherein the generating of the at least one response is further based on the at least one navigational data.

7. The method of claim 4 wherein the at least one user device comprises at least one sensor, wherein the at least one sensor is further configured for generating at least one contextual information associated with the at least one query based on detecting at least one of a verbal cue and a nonverbal cue associated with the at least one user, wherein the generating of the at least one response is further based on the at least one contextual information.

8. The method of claim 1 wherein the at least one user device comprises at least one input sensor, wherein the at least one input sensor is further configured for generating the at least one input sensor data based on detecting at least one of a gesture, a movement, an expression of the at least one user, wherein the at least one input further comprises the at least one input sensor data.

9. The method of claim 1 further comprises:
receiving, using the communication device, at least one requirement of the at least one user from the at least one user device; and
identifying, using the processing device, at least one first real estate property from the at least one real estate property based on the at least one requirement and the at least one real estate data, wherein the determining of the at least one exploring parameter is further based on the identifying of the at least one first real estate property, wherein the rendering of the exploring of the at least one interactive representation for the at least one user comprises rendering exploring of at least one first digital representation of the at least one first real estate property and at least one first information associated with the at least one first real estate property based on the at least one exploring parameter and the at least one interactive representation.

10. The method of claim 1 wherein the obtaining further comprises obtaining the at least one real estate data from at least one external device, wherein the at least one external device is configured for generating the at least one real estate data in real time.

11. A system for facilitating interactive search and discovery of real estate properties, the system comprising:
a communication device is configured for:
receiving at least one request from at least one user device associated with at least one user;
transmitting the at least one interactive representation to the at least one user device;
receiving at least one input from the at least one user device; and
transmitting at least one exploring parameter to the at least one user device, wherein the at least one user device is configured for rendering exploring the at least one interactive representation for the at least one user based on the at least one exploring parameter and the at least one interactive representation;
a storage device communicatively coupled with the communication device, wherein the storage device is configured for retrieving at least one digital twin of at least one geographical area based on the at least one request, wherein the at least one digital twin further comprises at least one digital representation of at least one real estate property associated with the at least one geographical area; and
a processing device communicatively coupled with the storage device, wherein the processing device is configured for:
obtaining at least one real estate data associated with the at least one real estate property based on the at least one request;
generating the at least one interactive representation of the at least one geographical area based on the at least one digital twin and the at least one real estate data, wherein the at least one interactive representation further comprises at least one information associated with the at least one real estate property; and
generating the at least one exploring parameter for the exploring of the at least one interactive representation based on the at least one input.

12. The system of claim 11, wherein the processing device is further configured for generating at least one avatar of the at least one user in the at least one interactive representation, wherein the at least one exploring parameter further comprises at least one navigational parameter for navigating the at least one avatar to at least one location in the at least one interactive representation, wherein the at least one user device is further configured for rendering the navigating of the at least one avatar to the at least one location in the at least one interactive representation, wherein the at least one avatar is associated with at least one view perspective based on the navigating, wherein the rendering of the exploring is further based on the at least one view perspective.

13. The system of claim 12, wherein the processing device is further configured for populating the at least one digital twin with at least one first avatar based on the at least one digital twin, wherein the generating of the at least one interactive representation is further based on the populating, wherein the at least one first avatar provides responses to queries directed to the at least one first avatar.

14. The system of claim 13, wherein the at least one avatar navigates to the at least one first avatar based on the at least one navigational parameter, wherein the processing device is further configured for:
generating at least one prompt for the at least one user based on navigating the at least one avatar to the at least one first avatar; and
generating at least one response for at least one query directed towards the at least one first avatar using at least one of a machine learning model and a natural language processing model associated with the at least one first avatar, wherein the communication device is further configured for:
transmitting the at least one prompt to the at least one user device;
receiving the at least one query for the at least one first avatar from the at least one user device; and
transmitting the at least one response to the at least one user device, wherein the at least one user device is further configured for rendering providing the at least one response from the at least one first avatar based on the at least one response.

15. The system of claim 14, wherein each of the at least one first avatar is associated with a role, wherein the role characterizes each of the at least one first avatar, wherein the generating of the at least one response for the at least one query directed towards the at least one first avatar is further based on the role of each of the at least one first avatar.

16. The system of claim 14, wherein the processing device is further configured for generating at least one navigational data associated with the navigation of the at least one avatar to the at least one location in the at least one interactive representation, wherein the generating of the at least one response is further based on the at least one navigational data.

17. The system of claim 14, wherein the at least one user device comprises at least one sensor, wherein the at least one sensor is further configured for generating at least one contextual information associated with the at least one query based on detecting at least one of a verbal cue and a nonverbal cue associated with the at least one user, wherein the generating of the at least one response is further based on the at least one contextual information.

18. The system of claim 11, wherein the at least one user device comprises at least one input sensor, wherein the at least one input sensor is further configured for generating the at least one input sensor data based on detecting at least one of a gesture, a movement, an expression of the at least one user, wherein the at least one input further comprises the at least one input sensor data.

19. The system of claim 11, wherein the communication device is further configured for receiving at least one requirement of the at least one user from the at least one user device, wherein the processing device is further configured for identifying at least one first real estate property from the at least one real estate property based on the at least one requirement and the at least one real estate data, wherein the determining of the at least one exploring parameter is further based on the identifying of the at least one first real estate property, wherein the rendering of the exploring of the at least one interactive representation for the at least one user comprises rendering exploring at least one first digital representation of the at least one first real estate property and at least one first information associated with the at least one first real estate property based on the at least one exploring parameter and the at least one interactive representation.

20. The system of claim 11, wherein the obtaining further comprises obtaining the at least one real estate data from at least one external device, wherein the at least one external device is configured for generating the at least one real estate data in real time.
